(19) United States
(12) Patent Application Publication
(10) Pub. No.: US 2012/0194435 A1
(43) Pub. Date: Aug. 2, 2012

(54) MOUSE AND METHOD FOR PAIRING THE MOUSE WITH COMPUTER

(75) Inventors: CHIH-JEN TSAI, Tu-Cheng (TW); WEI-CHIH KUO, Tu-Cheng (TW)

(73) Assignee: HON HAI PRECISION INDUSTRY CO., LTD., Tu-Cheng (TW)

(21) Appl. No.: 13/326,338

(22) Filed: Dec. 15, 2011

(30) Foreign Application Priority Data
Jan. 28, 2011 (TW) 100103213

(51) Int. Cl. G06F 3/033

(52) U.S. Cl. 345/163

(57) ABSTRACT

A mouse includes a BLUETOOTH module, a display device, and a switch unit. The module searches within a range and discovers computers in which a function has been enabled. The display device displays identification information of the discovered computers. The switch unit is operable to scroll through the discovered computers and select one computer, and enable the module to establish a connection between the selected computer and the mouse.

### BACKGROUND

1. Technical Field

The embodiments of the present disclosure relate to wireless communication technology, and particularly to a mouse and a method for paring the mouse with a computer.

2. Description of Related Art

BLUETOOTH-capable mice are very popular. A BLUETOOTH mouse can only communicate with one computer at one time, so the BLUETOOTH mouse and a designated computer should be paired before communication. At present, a computer works as a master in enabling and disabling a pairing relationship between the BLUETOOTH mouse and the computer. For example, if a user intends to pair the BLUETOOTH mouse with another computer, the user has to use the designated computer to end the current pairing relationship, and log into another computer to pair with the BLUETOOTH mouse.

### BRIEF DESCRIPTION OF THE DRAWINGS

FIG. 1 is a block diagram of one embodiment of function modules of a mouse.

FIG. 2(I), FIG. 2(II), and FIG. 2(III) illustrate information displayable on a display device of the mouse.

FIG. 3 is a block diagram of one embodiment of function modules of a switch unit of the mouse.

FIG. 4 is a block diagram of one embodiment of function modules of a switch button of the mouse.

FIG. 5 is a flowchart of one embodiment of a method for pairing the mouse with a computer.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

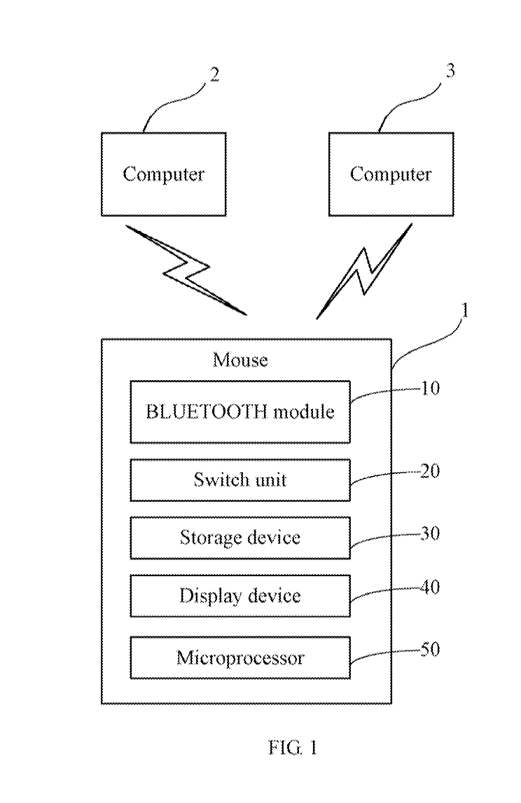

FIG. 1 is a block diagram of one embodiment of the function modules of a mouse 1 which is able to communicate wirelessly via the BLUETOOTH method or protocol (hereinafter, BLUETOOTH mouse 1). In one embodiment, the BLUETOOTH mouse 1 includes a BLUETOOTH module 10, a switch unit 20, a storage device 30, a display device 40, and a microprocessor 50. The mouse 1 uses the BLUETOOTH module 10 discover one or more BLUETOOTH-enabled computers within a range of the mouse 1. A BLUETOOTH-enabled computer may communicate with other devices via BLUETOOTH technology within the range. The range may be around 33 feet (ten meters), in one example. For example, as shown in FIG. 1, computer 2 and computer 3 are discoverable (e.g., searchable) by the BLUETOOTH module 10. The mouse 1 may further include three standardized buttons (not shown), such as a left button, a middle button (also functioning as a mouse wheel), and a right button. The primary functions of the three buttons are to navigate and/or make selections within a graphic user interface of a computer which the mouse 1 is in communication with.

The storage device 30 stores identification (ID) information of the discovered computers. In one embodiment, the ID information may be IP addresses, media access control addresses, or other information that may distinguish one discovered computer from another. The storage device 30 may be a smart media card, a secure digital card, a compact flash card, or any other type of suitable memory card.

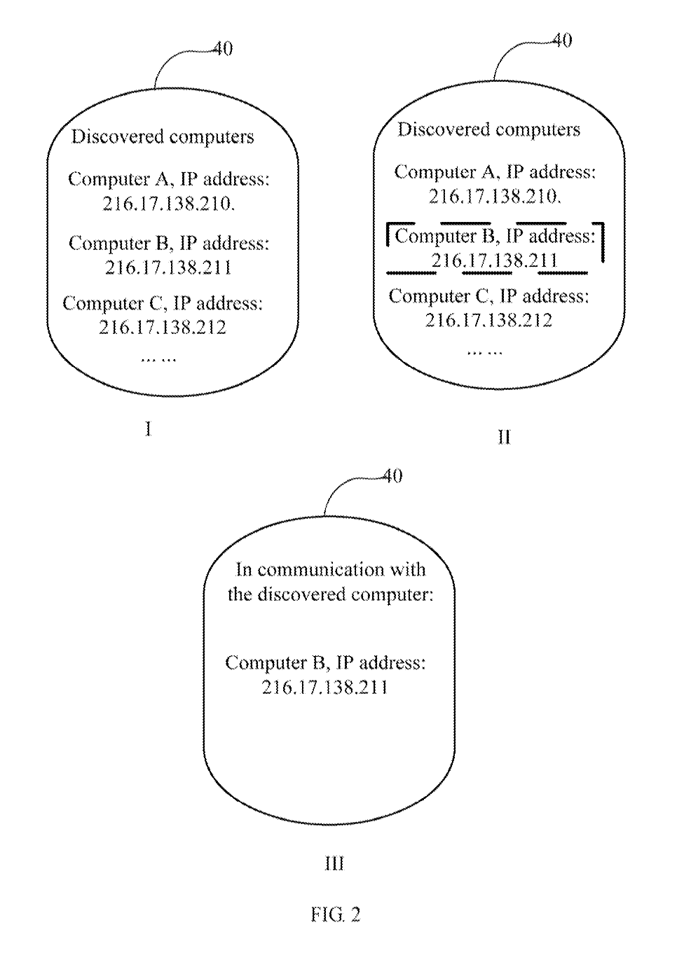

The display device 40 displays the ID information of the discovered computers. For example, as shown in FIG. 2, the display device 40 may display the following information in relation to one or more discovered computers “computer A, IP address: 216.17.138.210, computer B, IP address: 216.17.138.211, computer C, IP address: 216.17.138.212 . . . ”.

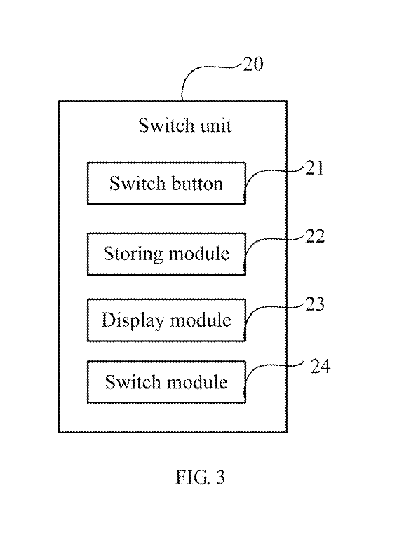

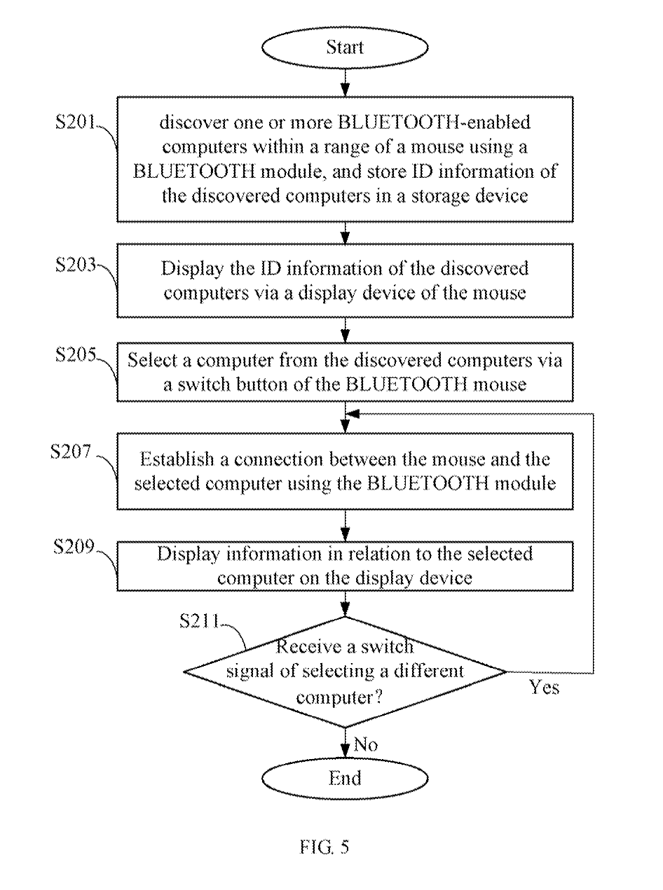

The switch unit 20 may receive a selection signal from a user as to the selection of one computer among the discovered computers, and enable the BLUETOOTH module 10 to establish a connection between the selected computer and the mouse 1. The switch unit 20 may also enable the BLUETOOTH module 10 to end the current connection and establish a new connection between the mouse 1 and a different computer in response to receiving a switch signal of selecting a different discovered computer from a user. As shown in FIG. 3, the switch unit 20 includes a switch button 21, a storing module 22, a display module 23, and a switch module 24. The modules 21-24 may include computerized code in the form of one or more programs (computer-readable program code) that are stored in the storage device 30. The computerized code includes instructions to be executed by the microprocessor 50 to provide the above-mentioned functions of the switch unit 20. A detailed description of the modules 21-24 is given and illustrated in FIG. 5.

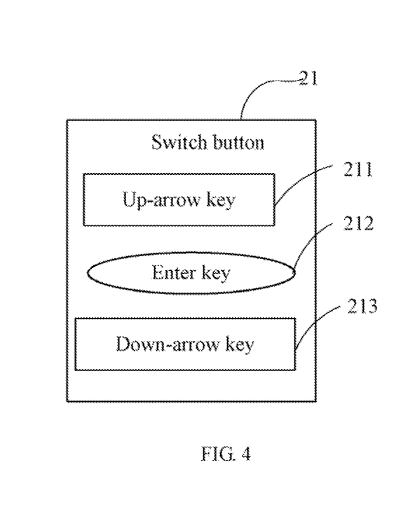

In one embodiment, as shown in FIG. 4, the switch button 21 may include an up-arrow key 211, an enter key 212, and a down-arrow key 213. If the display device 40 is too small to display all the discovered computers, the user can use the keys 211 and 213 to scroll through the discovered computers on the display device 40 until reaching a desired computer (such as computer B shown in FIG. 2(I)), and then use the enter key 212 to select the desired computer and thus enable the BLUETOOTH module 10 to establish a connection between the desired computer and the mouse 1.

In other embodiments, the switch button 21 may utilize the three standardized buttons. In response to a pressing operation on the switch button 21, the left button, the middle button, and the right button of the mouse 1 may be made to respectively emulate an up-arrow key 211, an enter key 212, and a down-arrow key 213 described above. After a connection between the desired computer and the mouse 1 has been established, the user may press the switch button 21 again to resume the primary functions of the left button, the middle button, and the right button on the mouse 1.

FIG. 5 is a flowchart of one embodiment of a method for pairing the mouse 1 and a computer. Depending on the embodiment, additional blocks may be added, others removed, and the ordering of the blocks may be changed.

In block S201, the BLUETOOTH module 10 searches within a range and discovers computers in which the BLUETOOTH function has been enabled, the storing module 22 stores the ID information of the discovered computers in the storage device 30. As mentioned above, the ID information may be the IP addresses, media access control addresses, or other information that may distinguish one discovered computer from another.

In block S203, the display module 23 displays the ID information of the discovered computers on the display device 40 (As shown in FIG. 2(I)).

In block S205, the switch module 24 receives a signal as to the selection of one discovered computer, from the switch button 21. As shown in FIG. 2(II), the computer B has been selected by a user by means of the up-arrow key 211, the enter key 212, and the down-arrow key 213.

In block S207, the switch module 24 enables the BLUETOOTH module 10 to establish a connection between the selected computer and the mouse 1.

In block S209, the display module 23 displays the ID information of the selected computer on the display device 40 (as shown in FIG. 2(III)), to indicate which computer the mouse 1 is paired with.

In block S211, the switch module 24 may detect a signal from the switch button 21 to switch to a different computer. If a signal to switch to a different computer (such as the computer A) has been received from the switch button 21, the switch module 24 enables the BLUETOOTH module 10 to end the current connection, and the procedure returns to block S207 so that a new connection between the mouse 1 and the different computer may be made.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being performed by execution of instructions by a microprocessor of a mouse for paring the mouse with a computer, the method comprising:
discovering one or more BLUETOOTH-enabled computers within a range of the mouse using a BLUETOOTH module of the mouse, and storing identification (ID) information of the discovered computers into a storage device of the mouse;
displaying the ID information of the discovered computers on a display device of the mouse;
receiving a selection signal of selecting one computer from the discovered computers sent from a switch button of the mouse; and
establishing a connection between the selected computer and the mouse using the BLUETOOTH module.

2. The method of claim 1, further comprising:
ending the connection between the mouse and the selected computer using the BLUETOOTH module in response that a switch signal of selecting a different discovered computer has been received from the switch button; and
establishing a new connection between the different discovered computer and the mouse using the BLUETOOTH module.

3. The method of claim 1, further comprising: displaying the ID information of the selected computer on the display device, to indicate which computer the mouse is being paired with.

4. The method of claim 1, wherein the switch button comprises an up-arrow key and a down-arrow key for scrolling through the discovered computers on the display device, and an enter key for selecting the computer and enabling the connection between the selected computer and the mouse.

5. The method of claim 1, wherein the switch button is a button operable to activate a left button and a right button of the mouse to perform a function of scrolling through the discovered computers on the display device, and activate a middle button of the mouse to perform the function of selecting the computer and enabling the connection between the selected computer and the mouse.

6. The method of claim 5, wherein the switch button is further operable to resume primary functions of the left button, the middle button, and the right button of the mouse after the connection between the selected computer and the mouse has been established.

7. A mouse, comprising:
a BLUETOOTH module;
a storage device;
a display device;
a microprocessor;
a switch button; and
one or more programs stored in the storage device and being executable by the microprocessor, the one or more programs comprising instructions:
to discover one or more BLUETOOTH-enabled computers within a range of the mouse using the BLUETOOTH module of the mouse, and store identification (ID) information of the discovered computers into the storage device;
to display the ID information of the discovered computers on the display device; and
to receive a selection signal of selecting one computer from the discovered computers sent from the switch button; and
to establish a connection between the selected computer and the mouse using the BLUETOOTH module.

8. The mouse of claim 7, wherein the one or more programs further comprise instructions to end the connection between the mouse and the selected computer using the BLUETOOTH module in response that a switch signal of selecting a different discovered computer has been received from the switch button, and to establish a new connection between the different discovered computer and the mouse using the BLUETOOTH module.

9. The mouse of claim 7, wherein the one or more programs further comprise instructions to display the ID information of the selected computer on the display device, to indicate which computer the mouse is being paired with.

10. The mouse of claim 7, wherein the switch button comprises an up-arrow key and a downward-arrow key for scrolling through the discovered computers on the display device, and an enter key for selecting the computer and enabling the connection between the selected computer and the mouse.

11. The mouse of claim 7, wherein the switch button is a button operable to activate a left button and a right button of the mouse to perform a function of scrolling through the discovered computers on the display device, and activate a middle button of the mouse to perform the function of selecting the computer and enabling the connection between the selected computer and the mouse.

12. The mouse of claim 11, wherein the switch button is further operable to resume primary functions of the left button, the middle button, and the right button of the mouse after the connection between the selected computer and the mouse has been established.

13. A non-transitory medium storing a set of instructions, the set of instructions capable of being executed by a microprocessor of a mouse to perform a method for pairing the mouse with a computer, the method comprising:
discovering one or more BLUETOOTH-enabled computers within a range of the mouse using a BLUETOOTH module of the mouse, and storing identification (ID) information of the discovered computers into a storage device of the mouse;
displaying the ID information of the discovered computers on a display device of the mouse;
receiving a selection signal of selecting one computer from the discovered computers sent from a switch button of the mouse; and
establishing a connection between the selected computer and the mouse using the BLUETOOTH module.

14. The medium of claim 13, wherein the method further comprises:
ending the connection between the mouse and the selected computer using the BLUETOOTH module in response that a switch signal of selecting a different discovered computer has been received from the switch button; and
establishing a new connection between the newly selected computer and the mouse using the BLUETOOTH module.

15. The medium of claim 13, wherein the method further comprising: displaying the ID information of the selected computer on the display device, to indicate which computer the mouse is being paired with.

16. The medium of claim 13, wherein the switch button comprises an up-arrow key and a down-arrow key for scrolling through the discovered computers on the display device, and an enter key for selecting the computer and enabling the connection between the selected computer and the mouse.

17. The medium of claim 13, wherein the switch button is a button operable to activate a left button and a right button of the mouse to perform a function of scrolling through the discovered computers on the display device, and activate a middle button of the mouse to perform the function of selecting the computer and enabling the connection between the selected computer and the mouse.

18. The medium of claim 17, wherein the switch button is further operable to resume primary functions of the left button, the middle button, and the right button of the mouse after the connection between the selected computer and the mouse has been established.
